(19) United States
(12) Patent Application Publication
(10) Pub. No.: US 2005/0093272 A1
(43) Pub. Date: May 5, 2005

(54) Guard for the draw bar of a trailer hitch for a vehicle

(76) Inventor: Peter J. Adams, London (CA)

Correspondence Address: ROBERT F. DELBRIDGE;GOWLING LAFLEUR HENDERSON LLP, 560-120 KING STREET WEST, HAMILTON, ON, L8N 4R3, CA

(21) Appl. No.: 10/940,669

(22) Filed: Sep. 15, 2004

Related U.S. Application Data
(60) Provisional application No. 60/502,944, filed on Sep. 16, 2003.

(51) Int. Cl. B60D 1/00

(52) U.S. Cl. 280/507

(57) ABSTRACT

A guard for the draw bar of a vehicle trailer hitch, said guard having a main body with an aperture shaped to enable the main body to be assembled with the draw bar by sliding the draw bar therethrough so that the main body extends transversely of the draw bar on each side thereof, and a guard portion extending in a loop-like manner from adjacent to one end of the main body for a distance forwardly of the body and then to adjacent an opposite end of the main body whereby, when the main body is mounted on the draw bar, a rearwardly projecting end portion of the draw bar is located within the loop formed by the guard portion.

### RELATED APPLICATION

This application claims priority from U.S. Provisional Patent Application No. 60/502944 filed Sep. 16, 2003.

### FIELD OF INVENTION

This invention relates to a guard for the draw bar of a trailer hitch for a vehicle.

### BACKGROUND OF INVENTION

Draw bars of such trailer hitches usually project from the rear of the vehicle, and it is relatively easy for a person walking behind the vehicle to accidentally injure a leg by engagement with the draw bar.

It is therefore an object of the invention to provide a suitable guard to reduce the risk of such an accident occurring.

### SUMMARY OF INVENTION

According to the invention, a guard for the draw bar of a vehicle trailer hitch has a main body with an aperture shaped to enable the main body to be assembled with the draw bar by sliding the draw bar therethrough so that the main body extends transversely of the draw bar on each side thereof, and a guard portion extending in a loop-like manner from adjacent to one end of the main body for a distance forwardly of the body and then to adjacent an opposite end of the main body whereby, when the main body is mounted on the draw bar, a rearwardly projecting end portion of the draw bar is located within the loop formed by the guard portion.

The guard portion may comprise a semi-rigid tube, and the main body may have apertures which receive opposite ends of the tube.

### BRIEF DESCRIPTION OF THE DRAWINGS

One embodiment of the invention will now be described, by way of example, with reference to the accompanying drawings, of which:

FIG. 1 is a diagrammatic perspective view of a draw bar guard in accordance with one embodiment of the invention mounted on the draw bar of a hitch secured to the rear of a vehicle,

FIG. 2 is an enlarged view of the guard and draw bar,

FIG. 3 is an exploded perspective view of front of the guard showing the guard in more detail, and

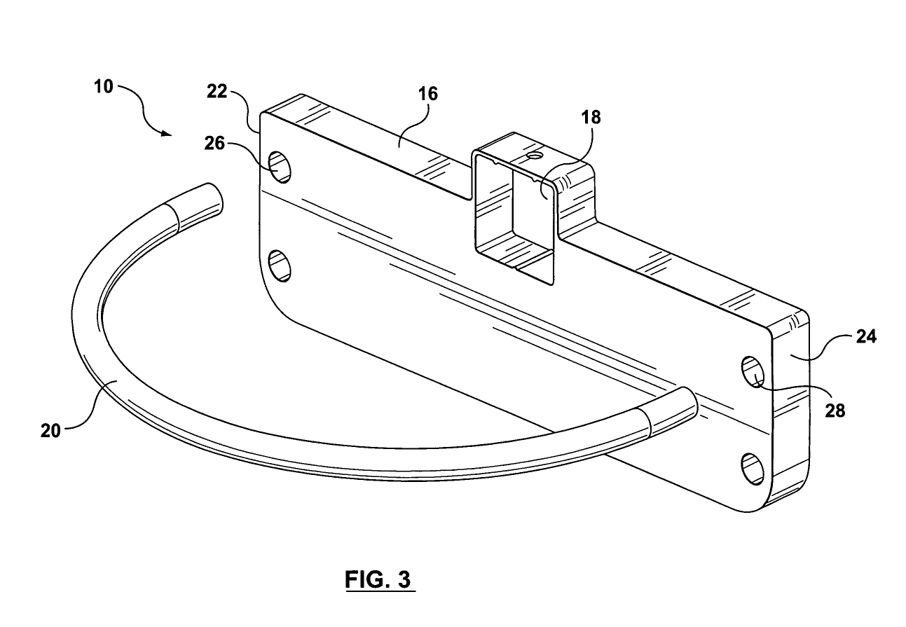

FIG. 4 is a similar view of the rear of the guard.

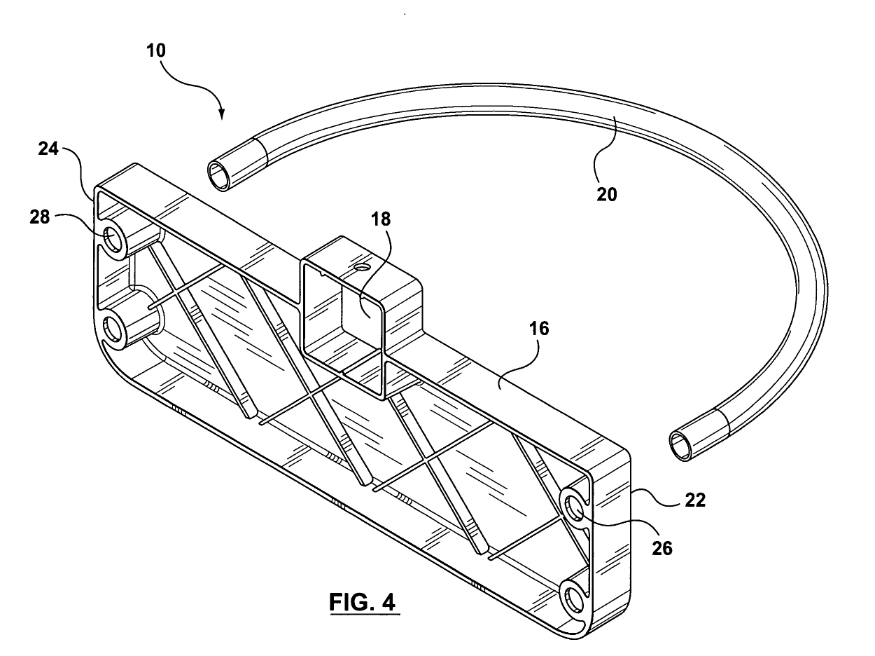

### DESCRIPTION OF PREFERRED EMBODIMENT

Referring to the drawings, a guard 10 in accordance with one embodiment of the invention is mounted on the draw bar 12 of a hitch which projects from the rear of a pick up truck 14. It will be understood that the draw bar 12 is detachably secured in a conventional manner by sliding movement into a portion of the hitch (not shown) secured to the pick up truck 14.

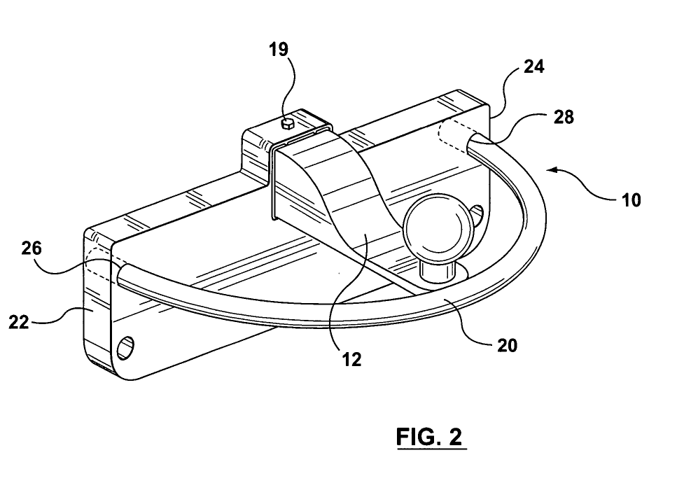

The guard 10 has a main body 16 of metal or plastic with an aperture 18 shaped to enable the main body 18 to be assembled with the draw bar 12 by sliding the draw bar 12 through the aperture 18 before the draw bar 12 is secured to the pick up truck 14 so that the main body 16 extends transversely on each side of the draw bar 12. The guard 10 can be retained in place on the draw bar 12 by a set screw 19 (see FIG. 2).

A guard portion 20 comprises a length of semi-rigid plastic pipe or metal tube extending in a loop-like manner from adjacent one end 20 of the main body 16 for a distance forwardly of the main body 16 and back to adjacent to the opposite end 22 of the main body 16. The main body 16 has cylindrical attachment members 26, 28 at opposite ends 22, 24 with apertures which receive the ends of the guard portion 20 in frictional engagement therewith.

The rearwardly projecting end of the draw bar 12 is thus located within the loop formed by the guard portion 20, so that a person's leg would engage the somewhat resilient guard portion 20 and not the draw bar 12.

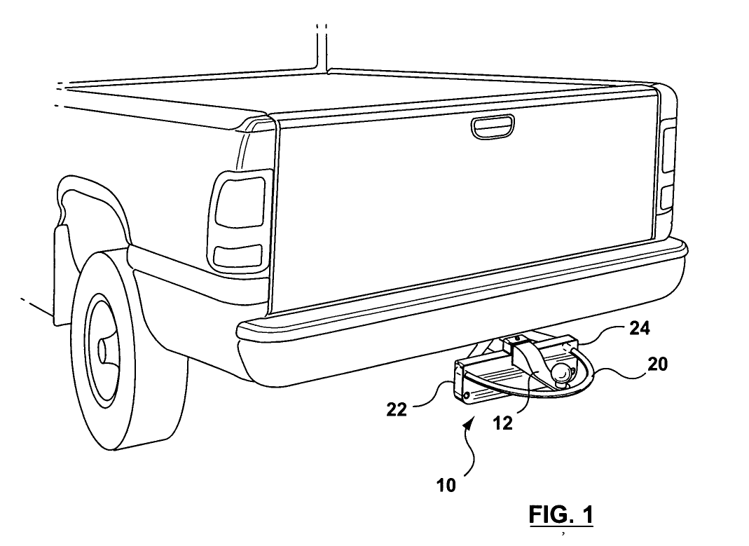

The manner in which the invention reduces the risk of a person hitting the draw bar 12 will be clearly evident from the above description and drawings of a preferred embodiment of the invention, see especially FIG. 1. Other embodiments of the invention will now also be readily apparent to a person skilled in the art, the scope of the invention being defined in the appended claims.

1. A guard for the draw bar of a vehicle trailer hitch, said guard having a main body with an aperture shaped to enable the main body to be assembled with the draw bar by sliding the draw bar therethrough so that the main body extends transversely of the draw bar on each side thereof, and a guard portion extending in a loop-like manner from adjacent to one end of the main body for a distance forwardly of the body and then to adjacent an opposite end of the main body whereby, when the main body is mounted on the draw bar, a rearwardly projecting end portion of the draw bar is located within the loop formed by the guard portion.

2. A guard according to claim 1 wherein the guard portion comprises a semi-rigid tube.

3. A guard according to claim 2 wherein the main body has apertures which receive opposite ends of the tube.

4. A vehicle having a trailer hitch with a draw bar and a guard therefor, the guard having a main body with an aperture shaped to enable the main body to be assembled with the draw bar by sliding the draw bar therethrough so that the main body extends transversely of the draw bar on each side thereof, and a guard portion extending in a loop-like manner from adjacent to one end of the main body for a distance forwardly of the body and then to adjacent an opposite end of the main body, a rearwardly projecting end portion of the draw bar being located within the loop formed by the guard portion.

5. A vehicle according to claim 4 wherein the guard portion comprises a semi-rigid tube.

6. A vehicle according to claim 5 wherein the main body of the guard has apertures which receive opposite ends of the tube.
